(19) United States
(12) Patent Application Publication
(10) Pub. No.: US 2011/0260066 A1
(43) Pub. Date: Oct. 27, 2011

(54) SOLID-STATE X-RAY DETECTOR

(75) Inventor: Gérard Vieux, Etat (FR)

(73) Assignee: TRIXELL S.A.S., MOIRANS (FR)

(21) Appl. No.: 13/129,310

(22) PCT Filed: Nov. 12, 2009
(86) PCT No.: PCT/EP2009/065066

§ 371 Date: Jun. 9, 2011

(30) Foreign Application Priority Data
Nov. 14, 2008 (FR) 0806377

(51) Int. Cl. G01T 1/20; B32B 37/12; B32B 37/14; B32B 37/02

(52) U.S. Cl. 250/361 R; 156/60

(57) ABSTRACT

A solid-state radiation detector comprises a photosensitive sensor associated with a radiation converter or scintillator. The fields of application of this type of detector are notably radiology: radiography, fluoroscopy and mammography, but also nondestructive testing. The detector comprises a rigid entrance window passed through by the first radiation upstream of the scintillator, the scintillator being placed between the sensor and the entrance window, the sensor comprising a substrate and photosensitive elements placed on the substrate. According to the invention, the entrance window is shaped so as to closely fit the form of the scintillator and is fixed in a moisture-tight manner on the substrate of the sensor.

The present invention relates to a solid-state X-ray detector comprising a photosensitive sensor associated with a radiation converter. The fields of application of this type of detector are notably radiology: radiography, fluoroscopy, mammography, but also nondestructive testing.

Such radiation detectors are for example described in French patent FR 2 803 081, in which a sensor formed from amorphous silicon photodiodes is associated with a radiation converter.

The operation and the structure of such a radiation detector will now be briefly reviewed.

The photosensitive sensor is generally fabricated from solid-state photosensitive elements arranged in a matrix. The photosensitive elements are fabricated from semiconductor materials, usually single-crystal silicon in the case of CCD or CMOS sensors, polycrystalline silicon or amorphous silicon. A photosensitive element comprises at least one photodiode, at least one phototransistor or at least one photoresistor. These elements are deposited on a substrate, generally a glass plate.

In general, these elements are not directly sensitive to radiation of very short wavelength, such as X-rays or gamma rays. This is why the photosensitive sensor is associated with a radiation converter, which comprises a layer of a scintillator substance. This substance has the property, when it is excited by such radiation, of emitting radiation of longer wavelength, for example visible or near-visible light, to which the sensor is sensitive. The light emitted by the radiation converter illuminates the photosensitive elements of the sensor, which perform a photoelectric conversion and deliver electrical signals that can be exploited by appropriate circuits. The radiation converter will be called a scintillator in the rest of the description.

Certain scintillator substances of the family of alkali metal halides or rare-earth metal oxysulfides are frequently employed for their good performance.

Among alkali metal halides, cesium iodide doped with sodium or with thallium, depending on whether it is desired for the emission to be at around 400 nanometers or around 550 nanometers respectively, is known for its strong X-ray absorption and for its excellent fluorescence yield. It takes the form of fine needles which are grown on a support. These needles are approximately perpendicular to this support and they partly confine the light emitted toward the sensor. Their fineness determines the resolution of the detector. Lanthanum oxysulfide and gadolinium oxysulfide are also widely used for the same reasons.

However, some of these scintillator substances have the drawback of being not very stable—they partially decompose when exposed to moisture and their decomposition releases chemical species that migrate either toward the sensor or away from the sensor, these species being highly corrosive. Notably, cesium iodide and lanthanum oxysulfide have this drawback.

As regards cesium iodide, its decomposition gives cesium hydroxide Cs⁺OH⁻ and free iodine I₂, which can then combine with iodide ions to give the complex I₃⁻.

As regards lanthanum oxysulfide, its decomposition gives hydrogen sulfide H₂S, which is chemically very aggressive.

Moisture is extremely difficult to eliminate. The ambient air and the adhesive used to assemble the detector always contain moisture. The presence of moisture in the adhesive is due either to ambient air, or it is a by-product of the cross-linking if this cross-linking results from the condensation of two chemical species, which is frequently the case.

One of the important aspects when producing these detectors is to minimize the amount of moisture initially present within the detector, and in contact with the scintillator, and to prevent said moisture from diffusing into the sensor during its operation.

The radiation detectors comprise an entrance window passed through by the X-rays upstream of the scintillator. Moreover, the scintillator substance is generally deposited on a metal holder. The holder and the scintillator substance then form the scintillator.

It is possible but not obligatory to use the holder as the entrance window.

When the scintillator substance is thus deposited on the entrance window so as to form the scintillator, which is then fastened by bonding on the sensor, the entrance window must withstand without damage the thermal stresses of the deposition and of the treatment of the scintillator and preferably have a thermal expansion coefficient of the same order of magnitude as that of the scintillator and that of the sensor, more particularly that of its substrate. It is thus possible to provide for the window to have a low Young's modulus, thereby preventing differential stresses between the window and the scintillator, on the one hand, and the window and the sensor, on the other, or more particularly the substrate of the sensor. Thus the risk of the scintillator cracking and of the substrate of the sensor breaking is alleviated.

The surface finish of the entrance window must in addition allow, notably for cesium iodide, growth of the finest possible needles, as uniformly as possible. The fineness of the needles is a quality factor for the resolution of the detector.

Currently holders are made of aluminum. The transparency of aluminum to the radiation to be detected is excellent, its optical properties are good. It is possible to obtain after treatment of the aluminum a surface finish that is good enough for the scintillator to be deposited thereon. Unfortunately, its expansion coefficient is very different from that of the sensor. To prevent substantial mechanical stresses at the interface between the two elements during thermal cycles, it is required to use a flexible seal capable of enduring the deformations related to these thermal cycles without being damaged. This seal is necessarily flexible so as to endure the differences in expansion between the holder of the scintillator and the sensor during thermal cycles, and to minimize the stresses and the risk of breakage. However, flexible materials are generally moisture permeable. Insufficient protection of the scintillator against this moisture results therefrom, thereby reducing the lifetime of the detector. It is desirable for such radiation detectors to have a lifetime comparable with the amortization timeframe of the radiology or other instruments on which they are mounted, this timeframe being about 10 years.

Another embodiment of the detectors has thus been developed, in which embodiment the entrance window and seal functions are not performed, as in the prior art described above, only by the holder of the scintillator.

In this embodiment, the entrance window is an additional element placed on the scintillator, without being fixed to the scintillator, and a moisture-tight seal completes the assembly of the entrance window and the sensor. In other words, the entrance window is fastened on the assembly formed by the sensor and the scintillator. The seal is produced between the entrance window and the sensor.

In this embodiment, the stresses to which the holder of the scintillator is subjected to are distributed between the holder and the actual novel entrance window. The holder of the scintillator is still subjected to the same reflectivity and surface finish constraints for the deposition of the scintillator substance as in the preceding structure. In contrast, it is no longer subjected to the constraints of moisture-tightness and of holding the seal. These constraints are transferred to the novel additional entrance window.

This embodiment makes it possible to use an entrance window material that is compatible with the material that the sensor is made of, notably in terms of the compatibility of their respective expansion coefficients, which must allow a harder, and therefore more moisture-impermeable, seal to be used.

By separating the entrance window and scintillator support functions, a far greater choice of materials is available to produce the entrance window.

This embodiment may be employed in two configurations of assembly of the scintillator and of the sensor.

In a first configuration, called the fastened scintillator configuration, the scintillator substance is deposited on a holder that the radiation to be detected must pass through before reaching the sensor. The assembly formed by the scintillator substance and its holder is then bonded on the sensor.

To do this an optical adhesive is used the object of which is to ensure a good mechanical contact between the scintillator and the sensor, but also a good transfer of the light emitted by the scintillator to the photosensitive sensor.

In a second configuration, called the direct deposition configuration, the sensor serves as a holder for the scintillator substance which is then in direct and intimate contact with the sensor. The two configurations each have advantages and drawbacks which are for example described in French patent FR 2 831 671.

Placing, above the scintillator, an entrance window that is independent of the scintillator nevertheless poses some problems such as notably the thickness of the seal fixing the entrance window to the sensor, which must be at least equal to the thickness of the scintillator. This type of thick seal is difficult to produce, especially in terms of the reproducibility of its moisture-tightness. It may for example not be homogenous and may contain bubbles that may lead to seal porosity. The volume of the seal may require a mold for its placement. A thick seal may also, for rheological reasons, flow and pollute regions of the detector where this is not desired.

The invention aims to obviate all or some of the aforementioned problems by providing for the placement of a fastened entrance window without requiring a thick seal.

For this purpose, one subject of the invention is a solid-state detector of a first radiation comprising a photosensitive sensor, a scintillator converting the first radiation into a second radiation to which the sensor is sensitive, and a rigid entrance window passed through by the first radiation upstream of the scintillator, the scintillator being placed between the sensor and the entrance window, the sensor comprising a substrate and photosensitive elements placed on the substrate, characterized in that the entrance window is shaped so as to closely fit the form of the scintillator, in that the entrance window is fixed in a moisture-tight manner on the substrate of the sensor.

Another subject of the invention is a method for producing a radiation detector according to the invention, characterized in that it consists in carrying out the following operations:
bonding the scintillator on the sensor;
placing the entrance window on the assembly formed by the sensor and the scintillator; and
bonding the entrance window on the sensor.

The invention will be better understood and other advantages will become clear on reading the detailed description of an embodiment given by way of example, which description is illustrated by the appended drawing in which:

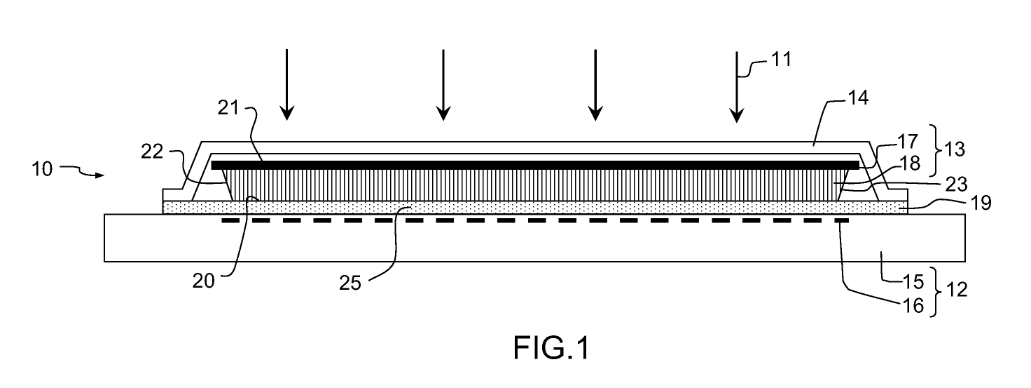

FIG. 1 shows an exemplary embodiment of a radiation detector according to the invention. For the sake of clarity, this FIGURE is not to scale.

The radiation detector 10, shown in FIG. 1, allows X-rays to be detected, the direction of which is shown by the arrows 11. The detector 10 comprises a sensor 12, a scintillator 13 converting the X-ray radiation into radiation to which the sensor 12 is sensitive, and a rigid entrance window 14 passed through by the X-ray radiation upstream of the scintillator 13.

The invention is described with respect to an X-ray detector. It is of course possible for the invention to be employed at other wavelengths requiring a scintillator.

The scintillator 13 is placed between the sensor 12 and the entrance window 14. The sensor 12 comprises a substrate 15 and photosensitive elements 16 placed on the substrate 15. Each photosensitive element 16 is mounted between a row conductor and a column conductor so as to be addressable. The row and column conductors are not shown in the FIGURE so as not to overcrowd it. The photosensitive elements 16 and the conductors are generally covered by a passivation layer intended to protect them from moisture. The scintillator 13 comprises a holder 17 and a scintillator substance 18 deposited on the holder 17. The scintillator substance 18 belongs, for example, to the alkali metal halide family, such as cesium iodide which is particularly sensitive to wet oxidation, but it could also belong to the rare-earth metal oxysulfide family certain members of which are also not very stable, such as lanthanum oxysulfide.

Advantageously, the holder 17 is passed through by the X-ray radiation upstream of the scintillator substance 18 and the scintillator 13 is fixed to the sensor 12 on the side of the scintillator substance 18.

The entrance window 14 is placed on the scintillator 13 without being fixed thereto. The entrance window 14 is rigid and is fixed in a moisture-tight manner on the substrate 15 of the sensor 13.

A hermetic seal 19 fixes the entrance window 14 to the substrate 15. The choice of material for the seal 19 is made depending on the materials of the entrance window 14 and of the substrate 15. The seal 19 may be based on an inorganic material. This type of seal has a very good impermeability but requires a high temperature, about 400° C.

Alternatively, the seal 19 may be based on an organic material. These materials are less moisture-tight than inorganic materials. But, in contrast, they require lower temperatures, lower than 200° C. Among organic materials the best moisture-tightness is ensured by epoxy adhesives.

The entrance window 14 may be made of any material the thermal expansion coefficient of which is similar to that of the material from which the substrate 15 is formed. Advantageously, the expansion coefficient of the entrance window is lower than that of aluminum. The proximity of the expansion coefficients of the two materials to be assembled, namely that of the entrance window 14 and that of the substrate 15 makes the use of a hard seal 19 possible.

Several materials are suitable for making the entrance window 14. Materials containing few heavy elements are in general suitable because of their good transparency to X-rays.

The entrance window 14 may contain glass. Glass is a one-component material and therefore easy to use. In addition, the substrate 15 may also contain glass. More generally, the entrance window 14 and the substrate 15 can be made of the same material or at least mainly of the same material, thereby limiting the difference between the thermal expansion coefficients of the entrance window 14 and the substrate 15. Carbon fibers may also be used to make the entrance window 14. Carbon fibers have a better transparency to X-rays than glass and are also less fragile. However, carbon fibers, often held in place using epoxy resin, are more difficult to seal due to their rough surface finish.

Alternatively, the entrance window 14 may comprise a ceramic material the transparency of which to X-rays is close to that of glass.

The entrance window 14 may also comprise an organic material, such as for example polyester. This material has a better transparency to X-rays than glass. It is also less fragile than glass. It is a homogenous material having a smooth surface finish when it is obtained by laminating or molding. Nevertheless, sealing polyester is a more delicate operation than sealing glass.

To minimize the thickness of the means for fixing the entrance window 14 on the substrate 15, the entrance window 14 is shaped so as to cover the scintillator 13 and lie as close as possible to the substrate 15. In other words, the entrance window 14 is shaped so as to closely fit the form of the scintillator 13 and thus reduce the thickness of the seal 19 so as to minimize the passage of moisture in the seal 19. More precisely, the scintillator 13 may be schematically represented as a parallelepiped a first front face 20 of which is placed against the photosensitive elements 16. A second front face 21, opposite the face 20 is passed through by the X-ray radiation. The scintillator 13 also comprises lateral faces substantially perpendicular to the two front faces 20 and 21. In FIG. 1, two lateral faces 22 and 23 are shown. The entrance window 14 is shaped so as to cover the front face 21 and the lateral faces.

The entrance window 14 may consist of a glass sheet which may easily be deformed to closely fit the form of the scintillator. The glass sheet may be heat formed. Heat forming consists in softening the glass at temperature and leaving it to take shape on a mold.

The glass sheet may be hollowed out by sandblasting. Sandblasting consists in projecting a jet of particles of a hard material, generally alumina or any other material, onto the glass sheets whilst preserving certain regions using a mask, especially the regions to be fixed on the substrate 15.

It is also possible to use caps made of carbon fibers formed by molding.

Advantageously, the scintillator 13 is fixed on the sensor 12 by means of an adhesive 25 that is transparent to the radiation to which the sensor 12 is sensitive. The entrance window 14 is fixed on the substrate 15 of the sensor 12 also by means of the adhesive 25. The adhesive 25 extends over the entire surface of the scintillator 13 facing the sensor 12. In other words, the same adhesive is used both as an optical adhesive between the scintillator 13 and the sensor 12 and as a seal between the entrance window 14 and the substrate 15. The seal 19 and the adhesive 25 form only one single element.

The use of the same element as seal 19 and adhesive 25 has several advantages: assembly embodiments in the detector 10 are simplified, the number of raw materials necessary to produce the detector 10 is reduced, and, therefore, the operation times and production costs are reduced.

The adhesive 25 is chosen for its transparency and its lack of defects, thereby directly contributing to the final image quality delivered by the detector 10. The adhesive 25 must also ensure the mechanical integrity of the optical interface between the photosensitive elements 16 and the scintillator substance 18.

The adhesive 25 must ensure a good mechanical connection between the substrate 15 and the entrance window 14. This connection must also be moisture-tight, either because of the intrinsic properties of the adhesive material 25, or because of its small thickness due to the substantial degree of confinement of the passage of the moisture provided by the entrance window 14 shaped to closely fit the scintillator 13.

The adhesive 25 may be a liquid adhesive deposited on the substrate 15 for example by screen printing, dip coating, offset printing, meniscus deposition, or any other dispensing means. The adhesive 25 may require an anneal or any other treatment before optical coupling with the scintillator substance 18 and deposition of the entrance window 14.

The adhesive 25 may also be deposited on the substrate 15 and applied in the form of a film taken from a roll, before optical coupling with the scintillator substance 18 and deposition of the entrance window 14.

The adhesive 25 may comprise an element belonging to one of the silicone, acrylic or epoxy adhesive families.

A method for producing a radiation detector according to the invention consists in carrying out the following operations:
bonding the scintillator 13 on the sensor 12;
placing the entrance window 14 on the assembly formed by the sensor 12 and the scintillator 13; and
bonding the entrance window 14 on the sensor 12.

When the same adhesive 25 is used to assemble the scintillator 13 and the entrance window 14 on the substrate 15, the method consists in:
bonding the scintillator 13 on the sensor 12 by means of an adhesive film 25; and
bonding the entrance window 14 on the sensor 12 by means of the adhesive film 25.

1. A solid-state detector of a first radiation comprising:
a photosensitive sensor,
a scintillator converting the first radiation into a second radiation to which the sensor is sensitive, and
a rigid entrance window passed through by the first radiation upstream of the scintillator, the scintillator being placed between the sensor and the entrance window, the sensor comprising a substrate and photosensitive elements placed on the substrate, wherein
the entrance window is shaped so as to closely fit the form of the scintillator, the entrance window being fixed in a moisture-tight manner on the substrate of the sensor,
the scintillator comprises a holder and a scintillator substance deposited on the holder, the holder being passed through by the first radiation upstream of the scintillator substance,
the scintillator is fixed to the sensor on the side of the scintillator substance and
the entrance window is placed without being fixed on the scintillator.

2. The detector according to claim 1, wherein
the scintillator comprises a front face passed through by the first radiation and lateral faces, and
the entrance window covers the front face and the lateral faces of the scintillator.

3. The detector according to claim 1, wherein
the scintillator is fixed on the sensor by means of an adhesive transparent to the second radiation to which the sensor is sensitive, and
the entrance window is fixed on the substrate of the sensor by means of the adhesive.

4. The detector according to claim 3, wherein the adhesive extends over the entire surface of the scintillator facing the sensor.

5. The detector according to claim 3, wherein the adhesive comprises an element belonging to one of the silicone, acrylic or epoxy adhesive families.

6. The detector according to claim 1, wherein the entrance window and the substrate of the sensor mainly comprise the same material.

7. The detector according to claim 1, wherein the entrance window comprises an element belong to an assembly comprising glass, carbon fibers, a ceramic material and an organic material.

8. An X-ray detector according to claim 1, wherein
the scintillator comprises a holder and a scintillator substance deposited on the holder, and
the scintillator substance comprises a material belonging to the alkali metal halides such as cesium iodide or rare-earth metal oxysulfides such as lanthanum oxysulfide.

9. A method of producing a radiation detector according to claim 1, the method comprising:
bonding the scintillator on the sensor;
placing the entrance window on the assembly formed by the sensor and the scintillator; and
bonding the entrance window on the sensor.

10. The method according to claim 9, wherein
the step of bonding the scintillator on the sensor includes bonding by means of an adhesive film; and
the step of bonding the entrance window on the sensor includes bonding by means of the adhesive film.
